(19) United States
(12) Patent Application Publication
(10) Pub. No.: US 2025/0282283 A1
(43) Pub. Date: Sep. 11, 2025

(54) MOTOR VEHICLE WITH PROJECTION SYSTEM

(71) Applicant: Audi AG, Ingolstadt (DE)

(72) Inventor: Paul BÖCKENHOFF, Ingolstadt (DE)

(73) Assignee: Audi AG, Ingolstadt (DE)

(21) Appl. No.: 19/071,562

(22) Filed: Mar. 5, 2025

(30) Foreign Application Priority Data
Mar. 6, 2024 (DE) 10 2024 106 429.3

(51) Int. Cl. B60Q 1/50; B60Q 1/00; B60Q 1/48; B62D 15/02

(52) U.S. Cl. CPC B60Q 1/507; B60Q 1/0023; B60Q 1/484; B60Q 1/488; B60Q 1/543; B62D 15/0285; B60Q 2400/50; B60Q 2800/10

(57) ABSTRACT

The present disclosure relates to a motor vehicle, including a projection system having at least one first and at least one second projection device. The at least one first projection device has at least one first light source and the at least second projection device has at least one second light source, where at least one first light projection can be projected into surroundings of the motor vehicle by the at least first projection device. The at least first light projection defines an actual position of the stationary motor vehicle, and at least one second light projection can be projected into surroundings of the motor vehicle by the at least second projection device. The at least second light projection defines a target position defining a parking position of the motor vehicle. The at least second projection device can be set by the user to change the target position. A deviation between the actual position and the target position can be determined via a detection device. Depending on the determined deviation, control parameters for performing an autonomous driving maneuver, in the context of which the motor vehicle can be maneuvered autonomously into the parking position, can be determined via a control device.

### TECHNICAL FIELD

The present disclosure relates to a motor vehicle comprising a projection system having at least one first and at least one second projection device, wherein the at least first projection device has at least one first light source, and the at least second projection device has at least one second light source.

### BACKGROUND

Modern motor vehicles often have parking assistance systems. These parking assistance systems usually comprise functions and apparatuses that allow the user to operate the motor vehicle more conveniently and to handle parking more easily. They include, for example, rear-view cameras, lateral parking aids, automatic parking and reversing assistants or even remote-controlled parking using an external control unit.

DE 10 2018 220 325 A1 discloses a projection apparatus with the help of which a parking maneuver can be performed. A user who controls the vehicle receives a visible representation of the vehicle trajectory, which the user can use to identify potential collisions. To use the projection apparatus, an indicator, which is arrows or a wayline, can be projected onto the ground to provide a visible representation of the target route.

DE 10 2017 210 221 A1 describes a method for the longitudinal and lateral control of a motor vehicle. In this process, surroundings data regarding the motor vehicle are determined, and several possible trajectories are output depending thereon. The user can select a trajectory via a control unit, whereby the motor vehicle is guided at least partially automatically along at least one section of the selected trajectory.

### BRIEF DESCRIPTION OF DRAWINGS/FIGURES

FIG. 1 illustrates a schematic diagram of a motor vehicle according to the present disclosure in which an exemplary embodiment of a method according to the present disclosure is carried out, wherein the target position is not set and the motor vehicle is not in a parking position.

FIG. 2 illustrates the motor vehicle and the exemplary embodiment according to FIG. 1, wherein the target position was adjusted by the user.

FIG. 3 illustrates the motor vehicle and the exemplary embodiment according to at least FIGS. 1 and 2, wherein the motor vehicle has performed the autonomous driving maneuver and is in the parking position.

FIG. 4 illustrates a block diagram of the method sequence.

### DETAILED DESCRIPTION

The present disclosure is based on the object of specifying an improved motor vehicle.

To achieve this object, a motor vehicle according to the present disclosure of the type mentioned above is provided, in which at least one first light projection can be projected into surroundings of the motor vehicle by the at least first projection device. The at least first light projection defines an actual position of the stationary motor vehicle, and at least one second light projection can be projected into surroundings of the motor vehicle by the at least second projection device. The at least second light projection defines a target position defining a parking position of the motor vehicle, wherein the at least second projection device can be set by the user to change the target position. A deviation between the actual position and the target position can be determined via a detection device, wherein, depending on the determined deviation, control parameters for performing an autonomous driving maneuver, in the context of which the motor vehicle can be maneuvered autonomously into the parking position, can be determined via a control device.

The motor vehicle according to the present disclosure thus has a projection system that outputs both a target position, with which a certain final position of the vehicle is to be represented after a maneuvering operation, as well as an actual position which defines the current position of the stationary motor vehicle. This has the advantage that this system allows for an accurate visualization of the actual and target position of the motor vehicle, whereby the deviation between the actual and target position is calculated via a detection device, and an autonomous driving maneuver is initiated via a control device. On the one hand, based on the actual target data, the control device can precisely detect the starting and the final position of the intended driving maneuver and, on the other hand, based on these position specifications or position deviations, determine a trajectory along which the vehicle can be maneuvered from the actual to the target position in an autonomous driving maneuver. A further advantage of this apparatus is that the user of the motor vehicle is enabled to optimally see both positions. Since the user can set the at least one second projection device independently, great flexibility is possible with regard to setting the target position to the desired position. The user can therefore define the desired parking position via the settable target position so that the vehicle is positioned as desired once the automatic driving maneuver has been performed. This makes it easier for the user to park in tight or difficult-to-see positions, for example at or between pillars, walls or parking cars. Furthermore, the representation of the two positions enables the user to intuitively operate the projection system in order to reach the desired parking position.

According to the present disclosure, the at least one first projection device and the at least one second projection device can be configured to generate at least one first and at least one second light projection which define an actual position and a target position to the side and/or in front of and/or behind the vehicle. In a preferred configuration of the present disclosure, the at least one first and the at least one second projection device are located on the side of the motor vehicle, which allows at least a representation of the actual and the target position laterally to the motor vehicle. This allows the position to be defined parallel to the vehicle's longitudinal axis. In addition, the actual and the target position can also be displayed at least partially in front of and/or behind the vehicle, which allows the position to be defined in the direction of the vehicle's longitudinal axis. Thus, two positions defining the final position—one to the side, the other to the front and/or rear—can be displayed simultaneously via a light projection. In addition, the user can also set the angle of the target position relative to the vehicle's longitudinal axis or to the actual position, which defines the current position of the vehicle and is therefore stationary, in order to achieve the setting of the desired parking position. This may be necessary in particular if the vehicle is to be maneuvered into a parking position obliquely to its current position. Furthermore, the at least one first and the at least one second light projection can be output with as little lateral offset as possible to the motor vehicle's longitudinal side. This makes it possible to output an as precise as possible representation of the position of the motor vehicle or its outside. This enables the user to better assess whether the target position they have chosen is suitable for reaching the desired parking position without collision.

According to a development of the present disclosure, the at least one first projection device and the at least one second projection device can be configured to generate at least one first and at least one second light projection in the form of lines. The advantage here is that the line representations more or less show the course of the longitudinal side of the vehicle or of the front or rear so that an output of these lines can offer the user the most vivid form of representation of the vehicle silhouette both in the actual position and in the target position. However, even more configurations are also conceivable. It is also possible to output the light projections in the form of dots, dashed lines or geometric shapes. It is also possible to set other user-specific display options such as color, intensity or line thickness.

Furthermore, the detection device can be a sensor, in particular an optical sensor, or a camera. In a configuration with the first alternative, sensors can be used to detect the light projections in particular in the form of lines. Examples include photoelectric sensors that can detect differences in brightness or color, for example. In the second alternative, the camera can preferably be configured for image analysis. For example, the actual position and target position shown in the form of lines can be detected by the camera and evaluated using dedicated software. Based on the detected positions and distances there between, the software can calculate and output a sensor detection result in the form of position data in which the control device can in turn be used to calculate its control parameters.

Furthermore, the at least one first light source and the at least one second light source of the projection system can each have at least one laser diode and/or at least one light-emitting diode (LED). An embodiment with a laser diode is preferred in this case. While both laser diodes and the LEDs are long-lasting, laser diodes compared to LEDs have the advantage that laser diodes do not lose light intensity even as they age. Since lasers operate in a narrow wave frequency range compared to LEDs, lasers produce high-intensity light and can also display it with greater precision than LEDs. Also, any geometry can be represented using lasers. Finally, ambient air that contains a lot of suspended particles, such as ones in a poorly ventilated parking garage, can adversely affect the light intensity of LEDs. The light intensity of lasers is not thereby impaired. Optionally, the at least one first and the at least one second light source can have both a laser diode and an LED. This would be advantageous in particular if there were a defect in one of the diodes since then at least the other diode would still be able to output the light projection.

Furthermore, according to the present disclosure, at least one first and at least one second projection device as well as at least one detection device can be provided on both sides of the motor vehicle. In a further preferred configuration of the present disclosure, the at least one first and the at least one second projection device and/or the detection device can be arranged on a side mirror, a roof rail, a sill or a bumper in the front and/or rear area. In the latter alternative, the projection devices are preferably mounted on the outer third of the bumper in order to allow the light projections to be deflected as far to the side as possible. While it is possible for the projection devices to be arranged on one side of the motor vehicle, a configuration in which additionally a further pair of projection devices comprising a first and a second projection device is arranged on the other side of the motor vehicle is favored. In this configuration, there would be a pair of projection devices on each side of the motor vehicle. With such an arrangement, the user can, depending on whether the potential parking position is to the left or right of the motor vehicle, select the at least one first and the at least one second projection device on one of the two sides, in order to output the at least one first and the at least one second light projection and to accordingly set the target position.

Moreover, a surroundings detection device can be provided which is configured to detect obstacles in the surroundings of the motor vehicle and to output surroundings detection information, wherein the control device is configured to determine the control parameters depending on the surroundings detection information. These can preferably be distance or proximity sensors such as ultrasonic, radar or lidar sensors. The control device can then determine control parameters depending on the surroundings detection information so that a potential obstacle can be avoided. The autonomous driving maneuver can be performed after the determination of these control parameters. The detection of an obstacle via the surroundings detection device has a protective function. The surroundings detection device can carry out continuous obstacle detection, the results of which are transmitted to the control device. As a result, both fixed obstacles such as walls, pillars, vehicles, etc. as well as moving obstacles can be detected. In case of an unforeseen situation, for example where a person steps in front of the vehicle as a moving obstacle, this can be detected by the surroundings detection device, transmitted to the control device, and the driving maneuver can then be aborted and resumed again once the obstacle is no longer in the path of travel. The user can then be asked to reset the target position. However, in such a situation where a driving maneuver may be aborted due to an unforeseen obstacle, it is also conceivable for the projection devices defining the target position to automatically define a preferred target position and output the corresponding light projections. Based on the newly set target position and surroundings detection information, the control device can calculate new control parameters on the basis of which a new driving maneuver can be performed. If a driving maneuver is aborted or if it is impossible to perform the driving maneuver, an acoustic warning signal can be output via loudspeakers, or a visual warning signal can be output via the headlights or the projection devices of the motor vehicle. Moreover, the user can also be sent a notification to their desired external control unit.

According to the present disclosure, a surroundings detection device can be provided which is configured to determine the surroundings of the motor vehicle and to output surroundings detection information, wherein the at least one first and the at least one second projection device are configured to control the at least one first and the at least one second light projection based on the surroundings detection information. Here, it is possible for the surroundings detection device to determine surroundings detection information, e.g., regarding the brightness of the surroundings or the dryness or condition of the surface serving as the roadway. Depending on the determined information, parameters can be changed via the projection devices that serve to better visualize the light projections. For example, in strong sunshine and thus high brightness, the color intensity of the light projections can be reduced and/or a darker color can be chosen so that the light projections stand out more clearly. Furthermore, on an uneven surface, for example on a gravel road, the strength of the displayed lines can be increased to make them more clearly visible. In addition to line thickness and intensity, it is also conceivable to set the color and brightness of the individual light projections. These settings can also be adapted individually by each user.

In a further configuration of the present disclosure, the at least one second projection device for setting the target position can be controlled by the user via an external and/or internal control unit. The external control unit can be a tablet, a laptop or a mobile phone, and the internal control unit can be a touch display installed in the vehicle. If the user sets the target position via an external control unit, the user is then preferably located outside the motor vehicle. For this purpose, a corresponding application can be loaded onto the external control unit of the user, via which the setting of the target position can be performed. In addition to setting the target position line which is parallel to the vehicle's longitudinal axis, the user can also set the target position lines, which are located in front of and/or behind the vehicle. The user can then define the positions in the direction of the vehicle's longitudinal axis, separately therefrom via the external control unit. Within the application, the motor vehicle, its surroundings and the actual position and target position output by the projection devices can be displayed, at least in a simplified display, e.g., in the form of lines. The user can then individually adapt the target position via the application by moving the line representing the target position with their finger. The shift of the target position can be tracked via the application and adjusted if necessary. At the same time, the shift of the target position can also be tracked in real time in the real motor vehicle. This offers the user a simple and convenient way to check the setting of the target position directly in the vehicle. To use an internal control unit, the user can remain in the vehicle and may not have to get out of the vehicle to set the target position. The manufacturer can pre-install software on the internal control unit, which software is configured to set the target position. To enable the user to take the surroundings into account while setting, at least one camera capturing the surroundings is additionally provided, preferably a camera that can be rotated by 360° so that the entire surroundings can be captured. Said camera can be used to capture the light projections of the at least one first projection unit and the at least one second production unit so that the representation of both the surroundings as well as the vehicle and the light projections can be shown in the form of lines on the display of the internal control unit. As with the use of the external control unit, when using the internal control unit, in addition to setting the target position line which is parallel to the vehicle's longitudinal axis, the user can also set separately therefrom the target position lines which are located in front of and/or behind the vehicle, and define the positions in the direction of the vehicle's longitudinal axis. The user can individually adapt the target position by moving the line that defines the target position with their finger. Here, too, the shift of the target position can be tracked via the display and readjusted if necessary. At the same time, the target position can be shifted in real time in the real motor vehicle. Once the user has completed setting the target position, the autonomous driving maneuver is preferably performed once the user has left the motor vehicle. Even though these examples illustrate situations in which an autonomous driving maneuver can be used for parking with the help of the projection system, the motor vehicle can of course also exit the parking space autonomously using the same steps explained.

In a development, the user can issue an authorization command via the external control unit and/or internal control unit for performance of the autonomous driving maneuver. This offers the advantage that the user retains final control over the autonomous driving maneuver and can be sure that the vehicle will not start moving without their confirmation. Here, too, various alternatives are again possible. The user can specify both the setting of the target position as well as the authorization command either via the external or internal control unit. However, it is also possible for the user to set the target position via the internal control unit, for example, but to issue the authorization command for performing the autonomous driving maneuver via the external control unit.

Furthermore, the autonomous driving maneuver can be performed depending on information regarding an occupancy state of the motor vehicle and/or a locking state of the motor vehicle and/or a settable time specification. These alternatives allow for individual adaptation to the needs of the user. For example, it is possible to set whether or not people are allowed to be inside the motor vehicle during the driving maneuver, with the driving maneuver preferably being performed when there are no people in the vehicle. In addition, the user can set whether the driving maneuver should be performed during an open or locked state of the vehicle, with a locked state being preferred. This offers the advantage that the vehicle is already locked during the parking process and the user does not forget to lock their vehicle. Furthermore, it is possible that a time limit within which the driving maneuver is to be performed can be freely set or can be set in certain time intervals, for example in 5-minute increments. For example, the driving maneuver can be performed 5 minutes after the authorization command if the user so wishes, with a timer starting, for example, when it is detected that the vehicle is locked or there are no longer any people in the vehicle. After completion of the driving maneuver, but also if the driving maneuver is aborted due to an unforeseen circumstance, a notification can be sent to the user's desired external control unit.

The present disclosure also relates to a method for automatically maneuvering a motor vehicle into a parking position, wherein the motor vehicle has a projection system that comprises at least one first and at least one second projection device, a detection device and a control device, comprising the steps of:
projecting at least one first light projection defining an actual position of the stationary motor vehicle by means of the at least first projection device into surroundings of the motor vehicle;
projecting at least one second light projection defining a target position which defines the parking position of the motor vehicle by means of the at least second settable projection device into the surroundings of the motor vehicle;
controlling the at least second, settable projection device set by the user for setting the target position;
detecting a deviation between the actual position and the target position via a detection device;
determining control parameters via a control device on the basis of the determined deviation by the detection device; and
automatically maneuvering the motor vehicle based on the control parameters.

All method- and apparatus-specific features that were disclosed for the motor vehicle according to the present disclosure of course also apply to the motor vehicle disclosed in the method. This also applies to all described alternative embodiments as well as to all combinations thereof, unless they are incompatible.

Additional advantages and details of the present disclosure result from the following described exemplary embodiments as well as from the drawings. The individual method steps are also discussed in more detail.

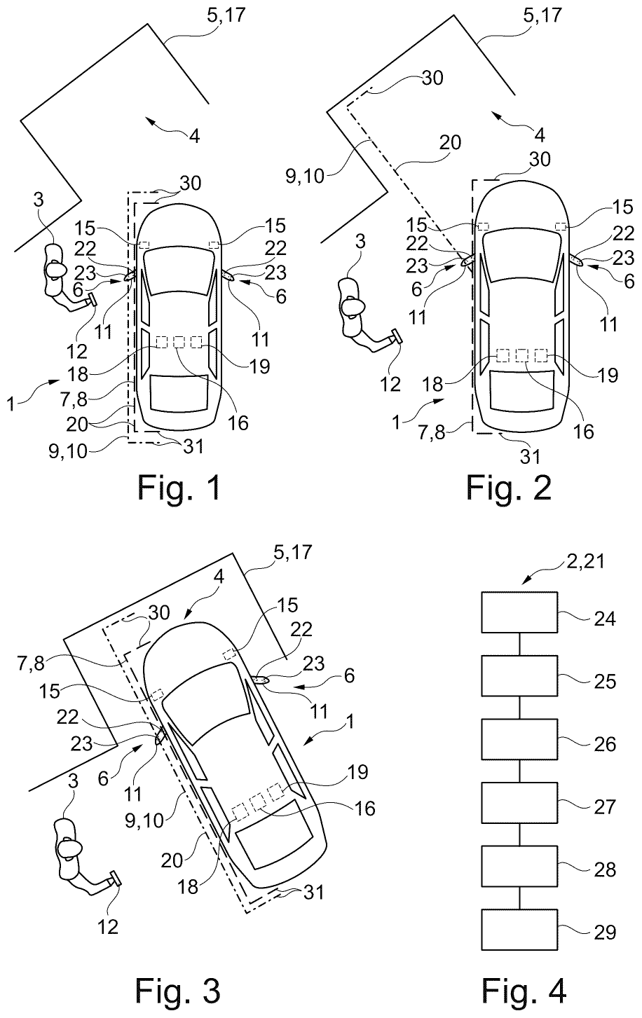

FIG. 1 illustrates a motor vehicle 1 according to the present disclosure configured to carry out the method 2 according to the present disclosure, wherein the motor vehicle 1 is in a starting position and not yet in the parking position 4 desired by the user 3. In this exemplary embodiment, the user 3 wants to move their motor vehicle 1 to the wall 5 and park it perpendicular thereto so that the bumper in the front area of the motor vehicle 1 is substantially parallel to the wall 5. To make this possible, the projection system 6 is activated in order to project, into the surroundings of the motor vehicle 1, the at least one first light projection 7, which defines the actual position 8, by means of the at least one first projection device 22. The project system 6 is also activated in order to project, into the surroundings of the motor vehicle 1, and the at least one second light projection 9, which defines the target position 10, by means of the at least one second projection device 23.

The at least one first projection device 22 and the at least one second projection device 23 are preferably located in at least one side mirror 11 of the motor vehicle 1. In FIG. 1, both projection devices 22, 23 are located in both side mirrors 11. Thus, depending on the direction in which the motor vehicle 1 is to be moved, the user 3 can select the desired side and activate the projection devices 22, 23. If, for example, as illustrated in FIG. 1, the user 3 wants to maneuver the motor vehicle 1 to the left relative to the vehicle's longitudinal axis in order to reach a parking position 4 between the walls 5, the user 3 can activate the projection devices 22, 23 in the left side mirror 11. The two light projections 7, 9 are preferably output in the form of lines 20 with as little lateral offset as possible to the longitudinal side of the motor vehicle 1. If the user 3 has not yet set the at least one second light projection 9 of the target position 10, it is in a starting position next to the at least one first light projection 7 of the actual position 8, as illustrated in FIG. 1.

During this process, the user 3 is preferably outside the motor vehicle 1 in order to set the target position 10 via the external control unit 12 or to give the authorization command for the autonomous driving maneuver. However, it is also possible for the user 3 to be inside the motor vehicle 1 and to enter the corresponding settings or commands via an internal control unit. If the user 3 is outside the motor vehicle 1, an application that is configured to control the light projection 9, which defines the target position 10, can be loaded onto the external control unit 12 desired by the user 3. In case the user 3 makes the setting via the internal control unit, the corresponding software can already be pre-installed on the internal control unit by the manufacturer. In both cases, the motor vehicle 1, its surroundings and both the actual position 8 and the target position 10 can be displayed in the form of lines in at least a simplified form within the application or the pre-installed software. The user 3 can then use their finger to move on the display the line that represents the target position 10 to the desired position. The user can track the movement of the line via the application or pre-installed software and adjust it if necessary. At the same time, the shift also takes place in real time so that the line 20 which represents the target position 10 can also be tracked in the real motor vehicle 1 by the user 3. In addition, the line 30 of the target position 10, which is aligned parallel to the front of the vehicle, and the line 31 of the target position 10, which is aligned parallel to the rear of the vehicle and which define the positions in the direction of the vehicle's longitudinal axis, can be displayed via the external 12 or internal control unit and individually set by the user 3.

FIG. 2 illustrates the next step of method 2. Here, the user 3 has set the at least one second light projection 9, which defines the target position 10, via the external control unit 12. A surroundings detection device 19 can determine surroundings detection information on the basis of which the light projections 7, 9 can be adapted to the given circumstances. In strong sunshine and thus high brightness, for example, the color intensity and/or the color of the lines 20 could be automatically adapted to be better visible to the user 3. As can be seen in FIG. 2, the new target position 10 has been set so that it leads close to the wall 5 and marks the parking position 4 desired by the user 3. The second light projection 9 was also changed in its angle, starting from the same second light projection 9 of FIG. 1. The at least one first light projection 7, which defines the actual position 8, remains unchanged with a slight lateral offset parallel to the longitudinal side of the motor vehicle 1. The setting of the target position 10 performed by the user thus leads to a deviation between the actual position 8 and the new target position 10 that marks a parking position 4. This deviation can be determined by the detection device 15 which preferably comprises optical sensors, a camera or a camera system comprising several individual cameras. At the same time, a surroundings detection device 16 can detect surroundings information regarding an obstacle in the surroundings of the motor vehicle 1. Said surroundings detection device 16 can, for example, comprise distance or proximity sensors such as ultrasonic, radar or lidar sensors.

In the example illustrated in FIG. 2, the surroundings detection device 16 detects the wall 5 as an obstacle 17. A control device 18 is in turn configured such that, depending on the information that it receives from the detection device 15 and the surroundings detection device 16, to determine control parameters for the autonomous maneuvering of the motor vehicle 1 into the parking position 4, via which the motor vehicle can maneuver during the maneuver, wherein multiple forward and reverse movements are possible in order to reach the final position.

FIG. 3 illustrates the motor vehicle 1 according to the present disclosure, wherein the motor vehicle 1 has performed the autonomous driving maneuver and is in the parking position 4. Once the user 3 has set the target position 10 via the external control unit 12 and the control device 18 has determined the control parameters, the user 3 can issue an authorization command for the autonomous driving maneuver via the external control unit 12. In addition, the user 3 can set the conditions under which the autonomous driving maneuver should take place. For example, the user can set whether the motor vehicle 1 should be open or locked during the driving maneuver, with a locked state being preferred. Furthermore, it can also be set whether people may be inside the motor vehicle 1 during the driving maneuver, unless the driver assistance system is by default configured such that the maneuver can be performed when there are no people in the vehicle, or in which period of time the driving maneuver should take place. If the user so wishes, they can, for example, set the autonomous driving maneuver to take place at a certain time after the authorization command has been issued. As soon as the user 3 has issued the authorization command and the autonomous driving maneuver starts, a permanent comparison takes place during the entire driving maneuver between the displayed target position 10, which was set by the user 3 via the external control unit 12 and on the basis of which the control device 18 has calculated the control parameters, and the position in which the motor vehicle 1 is at any given time during the driving maneuver. In addition, it is also possible to define and localize the target position 10 via global positioning system (GPS) data so that the control device 18 can additionally use this data to check whether the motor vehicle 1 is in the desired parking position 4. When a driving maneuver has been completed or when the driving maneuver is aborted due to unforeseen circumstances, the user 3 can receive a notification sent to their desired external control unit 12.

FIG. 4 illustrates a block diagram 21 of the method sequence according to present disclosure. In a first step 24, after activation of the projection system 6, the at least one first projection device 22 projects the at least one first light projection 7, which defines the actual position 8, into the surroundings of the motor vehicle 1. The actual position 8 marks the stationary motor vehicle 1. In the second step 25, the at least one second projection device 23 projects the at least one second light projection 9, which defines the target position 10, into the surroundings of the motor vehicle 1. As long as the user 3 has not yet set the at least one second light projection 9 via an external control unit 12 or an internal control unit, it is in the immediate vicinity of the at least one first light projection 7. In the third step 26, the user 3 can adjust the at least one second light projection 9 such that a target position 10 results which, for example, marks a parking position 4. In the fourth step 27, the deviation between the actual position 8 and the target position 10 can be determined via a detection device 15. At the same time, a surroundings detection device 16 can determine surroundings detection information regarding obstacles 17 in the surroundings of the motor vehicle 1. In the fifth step 28, a control device 18 can determine control parameters for executing the autonomous driving maneuver of the motor vehicle 1 based on the information determined by the detection device 15 and the surroundings detection device 16. In the sixth and final step 29, the autonomous driving maneuver of the motor vehicle 1 can be performed following an authorization command by the user 3 via the external control unit 12 or the internal control unit.

1-15. (canceled)

16. A motor vehicle comprising:
a projection system comprising:
at least one first projection device having at least one first light source, the at least one first projection device being configured to project at least one first light projection into surroundings of the motor vehicle, wherein the at least one first light projection defines an actual position of the motor vehicle;
at least one second projection device having at least one second light source, the at least one second projection device being configured to project at least one second light projection into the surroundings of the motor vehicle, wherein the at least one second light projection defines a target position of the motor vehicle, wherein the target position is indicative of a parking position, and wherein the at least one second projection device is further configured to change the target position based on a setting by a user;
a detection device configured to determine a deviation between the actual position and the target position; and
a control device configured to determine, based on the deviation, control parameters for performing an autonomous driving maneuver in support of maneuvering the motor vehicle autonomously into the parking position.

17. The motor vehicle according to claim 16, wherein the at least one first projection device and the at least one second projection device are configured to generate the at least one first light projection and the at least one second light projection.

18. The motor vehicle according to claim 17, wherein the at least one first light projection and the at least one second light projection define the actual position and the target position to at least a side of, in front of, or behind the motor vehicle.

19. The motor vehicle according to claim 16, wherein the at least one first projection device and the at least one second projection device are configured to generate the at least one first light projection and the at least one second light projection in a form of lines.

20. The motor vehicle according to claim 16, wherein the detection device is a sensor comprising an optical sensor, or a camera.

21. The motor vehicle according to claim 16, wherein each of the at least one first light source and the at least one second light source of the projection system has at least one laser diode or at least one light-emitting diode (LED).

22. The motor vehicle according to claim 16, wherein at least one of the at least one first projection device, the at least one second projection device, or the detection device are provided on both sides of the motor vehicle.

23. The motor vehicle according to claim 16, wherein at least one of the at least one first projection device, the at least one second projection device, or the detection device are arranged on a side mirror, a roof rail, a sill, or a bumper in at least one of a front or a rear area of the motor vehicle.

24. The motor vehicle according to claim 16, wherein a surroundings detection device is provided, the surroundings detection device configured to detect obstacles in the surroundings of the motor vehicle and to output surroundings detection information, and wherein the control device is configured to determine the control parameters based on the surroundings detection information.

25. The motor vehicle according to claim 24, wherein the autonomous driving maneuver is performed depending on the surroundings detection information.

26. The motor vehicle according to claim 16, wherein a surroundings detection device is configured to determine the surroundings of the motor vehicle and to output surroundings detection information, and wherein the at least one first projection device and the at least one second projection device are configured to control the at least one first light projection and the at least one second light projection based on the surroundings detection information.

27. The motor vehicle according to claim 16, wherein the at least one second projection device for setting the target position is controllable by the user via at least one of an external control unit or an internal control unit.

28. The motor vehicle according to claim 27, wherein the external control unit is at least one of a tablet, a laptop, or a mobile phone, and wherein the internal control unit is at least one of a touch display.

29. The motor vehicle according to claim 27, wherein at least one of the external control unit or the internal control unit is configured to receive an authorization command from the user, the authorization command causing the performing the autonomous driving maneuver.

30. The motor vehicle according to claim 16, wherein the autonomous driving maneuver is performed based on information regarding at least one of an occupancy state of the motor vehicle, a locking state of the motor vehicle, or a settable time specification.

31. A method for automatically maneuvering a motor vehicle into a parking position, wherein the motor vehicle has a projection system that comprises at least one first projection device, at least one second projection device, a detection device, and a control device, the method comprising:
projecting, by the at least one first projection device, at least one first light projection into surroundings of the motor vehicle, the at least one first light projection defining an actual position of the motor vehicle;
projecting, by the at least one second projection device, at least one second light projection into the surroundings of the motor vehicle, the at least one second light projection defining a target position, the target position being indicative of the parking position of the motor vehicle;
controlling, using a setting from a user, the at least second projection device to provide the target position;
determining, by the detection device, a deviation between the actual position and the target position;
determining, by the control device, control parameters on the basis of the deviation; and
automatically maneuvering the motor vehicle based on the control parameters.
